(19) United States
(12) Patent Application Publication
(10) Pub. No.: US 2024/0315915 A1
(43) Pub. Date: Sep. 26, 2024

(54) Leg synchronous massage mechanism with rotary rolling and linear rolling

(71) Applicant: Dong-Her Wu, CHANG-HUA HSIEN (TW)

(72) Inventor: Dong-Her Wu, CHANG-HUA HSIEN (TW)

(21) Appl. No.: 18/539,175

(22) Filed: Dec. 13, 2023

(30) Foreign Application Priority Data
Mar. 25, 2023 (TW) 112111602

(51) Int. Cl. A61H 15/00; A61H 1/00

(52) U.S. Cl. CPC A61H 15/0078; A61H 1/005; A61H 2015/0014; A61H 2201/0192; A61H 2201/1215; A61H 2201/149; A61H 2201/1654; A61H 2201/1669; A61H 2205/10

(57) ABSTRACT

A leg synchronous massage mechanism with rotary rolling and linear rolling, including a base, two rolling massage parts, a wheeling massage part, and two transmission rods. A power motor is provided in the base central part, and the power motor extends a power shaft on both sides. A sleeve shaft is sleeved on the power shaft for coaxial arrangement, the rolling massage part is protrudingly provided with an eccentric shaft, when the rolling massage part is driven using the power shaft as the axis, the eccentric shaft will deviate from the axis and rotate in a circular path. When the power motor outputs power to rotate, a crank slider mechanism is formed so that the rolling massage part can push and pull the wheeling massage part back and forth in a straight path when rotating.

### BACKGROUND OF THE INVENTION

### Field of the Invention

The present invention relates to a leg synchronous massage mechanism with rotary rolling and linear rolling, and particularly refers to a leg synchronous massage mechanism that can use different methods to massage the thighs and calves respectively at the same time.

### Description of the Related Art

Modern people pay more attention to physical health. Due to repetitive movements at work, school, and sports, it is easy to cause sports injuries, and long-term sitting and standing can cause muscle tightness and poor blood circulation. In addition, people are generally exhausted physically and mentally during rest time, so massage devices that can be used statically are a good choice for modern people.

Long-term standing can easily lead to soreness of the lower limbs, and when venous blood needs to be returned for a long time due to long-term standing, the pressure on the venous valves will be increased, which can easily cause varicose veins. Therefore, massaging the legs after work every day is beneficial to health. The thighs are thick and short, while the calves are thin and long, and therefore, the massage methods of thighs and calves are different. It is necessary to have a synchronous massage mechanism that can perform different massage methods at the same time.

### SUMMARY OF THE INVENTION

This invention provides a leg synchronous massage mechanism with rotary rolling and linear rolling, which can simultaneously use different methods to massage the user's thighs and calves respectively and has a symmetrical and stable structure.

The invention provides a leg synchronous massage mechanism with rotary rolling and linear rolling, including a base, two rolling massage parts, a wheeling massage part, and two transmission rods. The base has a base body, the base body is provided with a base central part in the center, a power motor is provided in the base central part, and the power motor extends a power shaft on both sides. The rolling massage part includes a rolling massage wheel, the rolling massage wheel has a sleeve shaft in the center, there are two shaft side parts on both sides of the sleeve shaft, the sleeve shaft is sleeved on the power shaft for coaxial arrangement, the rolling massage wheel has the power shaft as its axis to annularly provide at least one rolling massage unit between two shaft side parts, the rolling massage part is protrudingly provided with an eccentric shaft, when the rolling massage part is driven using the power shaft as the axis, the eccentric shaft will deviate from the axis and rotate in a circular path. The wheeling massage part has two symmetrically arranged wheeling massage pieces, the wheeling massage piece has an inner part and an outer part on both sides, there is at least one wheeling massage unit between the inner part and the outer part, the outer part is protruding with a driven shaft, and the two wheeling massage pieces are connected into one body with a connecting part. Both ends of the transmission rod are respectively provided on the eccentric shaft and the driven shaft, when the power motor outputs power to rotate, the rolling massage part, the transmission rod, the wheeling massage part, and the base cooperate with each other to form a crank slider mechanism so that the rolling massage part can push and pull the wheeling massage part back and forth in a straight path when rotating.

In another embodiment, the wheeling massage part has two symmetrically arranged wheeling massage pieces, the two sides of the wheeling massage piece have an inner part and an outer part respectively, a wheeling massage unit is equipped between the inner part and the outer part, two wheeling massage pieces are set on the wheeling massage piece shaft, a driven arm is provided on the left and right sides of the wheeling massage piece shaft, and the driven arm is provided with a driven arm shaft. Two ends of the transmission rod are respectively located on the eccentric shaft and the driven arm shaft, when the power motor outputs power to rotate, the rolling massage part, the transmission rod, and the wheeling massage part form a crank slider mechanism through transmission, so that when the roller massage part rotates, the wheeling massage part is pushed and pulled linearly back and forth.

Comparing the effectiveness of previous technologies, the present invention provides a leg synchronous massage mechanism with rotary rolling and linear rolling. When the power shaft rotates, the rolling massage part rotates accordingly, and the rolling massage unit contacts the thigh, so that massage can be performed by rotating and rolling. Due to the existence of the eccentric shaft, the wheeling massage part also performs linear reciprocating motion, so that the wheeling massage unit contacts the calf and can perform massage with linear wheel pressure, thereby achieving the function of massaging the thigh and the calf in different ways at the same time. The base, the rolling massage part, the wheeling massage part, and the transmission rods are all symmetrically arranged, so that the mechanism operates symmetrically, and the center of gravity is stable.

### BRIEF DESCRIPTION OF THE DRAWINGS

The following drawings are merely examples for illustrative purposes according to various disclosed embodiments and are not intended to limit the scope of the present disclosure.

FIG. 1 is a perspective view of the first embodiment of the present invention.

FIG. 2 is an exploded view of the first embodiment of the present invention.

FIG. 3 is a top view of the first embodiment of the present invention.

FIG. 4 is a side cross-sectional view of the first embodiment of the present invention.

FIG. 5 is a schematic top view of the first embodiment of the present invention in use.

FIG. 6 is the first schematic side view of the first embodiment of the present invention in use.

FIG. 7 is the second schematic side view of the first embodiment of the present invention in use.

FIG. 8 is the third schematic side view of the first embodiment of the present invention in use.

FIG. 9 is a schematic diagram of the first embodiment of the present invention covered in a shielding part.

FIG. 10 is the second schematic diagram of the first embodiment of the present invention covered in the shielding part.

FIG. 11 is the third schematic diagram of the first embodiment of the present invention covered in the shielding part.

FIG. 12 is an exploded view of another aspect of the first embodiment of the present invention.

FIG. 13 is a side cross-sectional view of another aspect of the first embodiment of the present invention.

FIG. 14 is an exploded view of the second embodiment of the present invention.

FIG. 15 is a top view of the second embodiment of the present invention.

FIG. 16 is the first schematic side view of the second embodiment of the present invention in use.

FIG. 17 is the second schematic side view of the second embodiment of the present invention in use.

FIG. 18 is the third schematic side view of the second embodiment of the present invention in use.

### DETAILED DESCRIPTION OF THE INVENTION

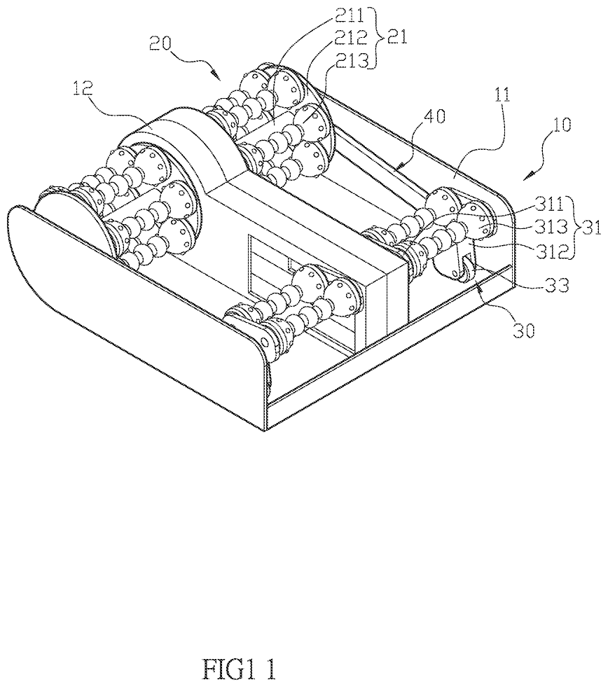

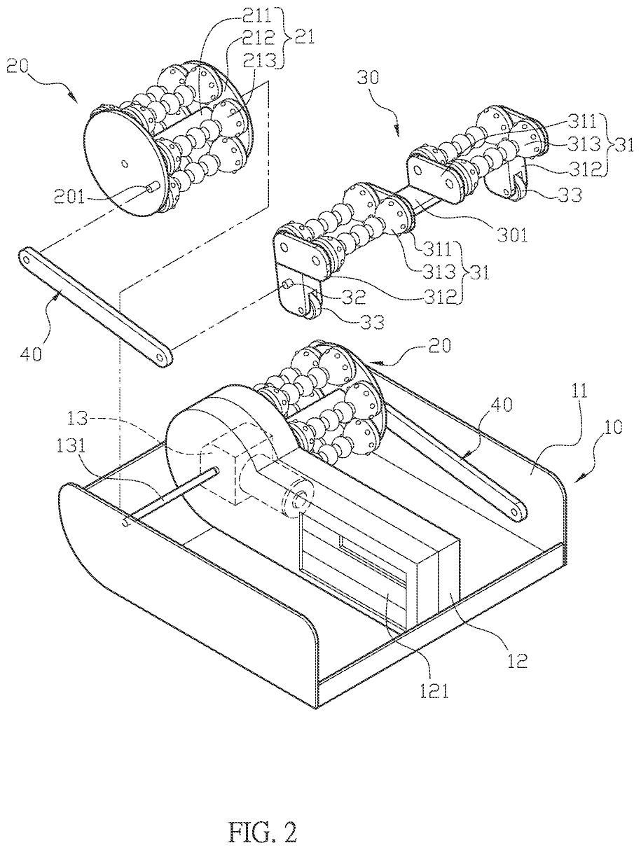

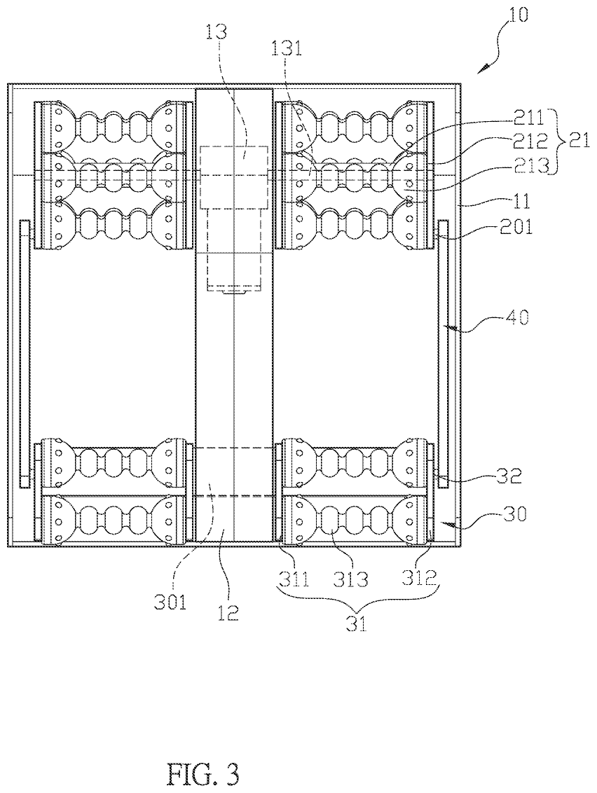

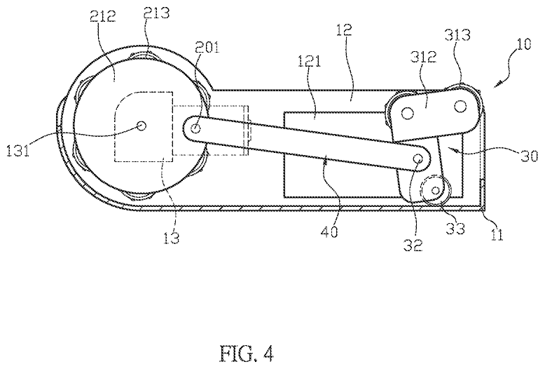

FIGS. 1-4 illustrate the first embodiment of the present invention. A leg synchronous massage mechanism with rotary rolling and linear rolling includes a base 10, two rolling massage parts 20, a wheeling massage part 30, and two transmission rods 40. The base 10 has a base body 11, the base body 11 is provided with a base central part 12 in the center, a power motor 13 is provided in the base central part 12, the power motor 13 extends a power shaft 131 on both sides.

The rolling massage part 20 includes a rolling massage wheel 21, the rolling massage wheel 21 has a sleeve shaft 211 in the center, there are two shaft side parts 212 on both sides of the sleeve shaft 211, the sleeve shaft 211 is sleeved on the power shaft 131 for coaxial arrangement, the rolling massage wheel 21 has the power shaft 131 as its axis to annularly provide at least one rolling massage unit 213 between two shaft side parts 212, the rolling massage part 20 is protrudingly provided with an eccentric shaft 201, when the rolling massage part 20 is driven using the power shaft 131 as the axis, the eccentric shaft 201 will deviate from the axis and rotate in a circular path.

The wheeling massage part 30 has two symmetrically arranged wheeling massage pieces 31, the wheeling massage piece 31 has an inner part 311 and an outer part 312 on both sides, there is at least one wheeling massage unit 313 between the inner part 311 and the outer part 312, the outer part 312 is protruding with a driven shaft 32, and the two wheeling massage pieces 31 are connected into one body with a connecting part 301.

Both ends of the transmission rod 40 are respectively provided on the eccentric shaft 201 and the driven shaft 32, when the power motor 13 outputs power to rotate, the rolling massage part 20, the transmission rod 40, the wheeling massage part 30, and the base 10 cooperate with each other to form a crank slider mechanism so that the rolling massage part 20 can push and pull the wheeling massage part 30 back and forth in a straight path when rotating.

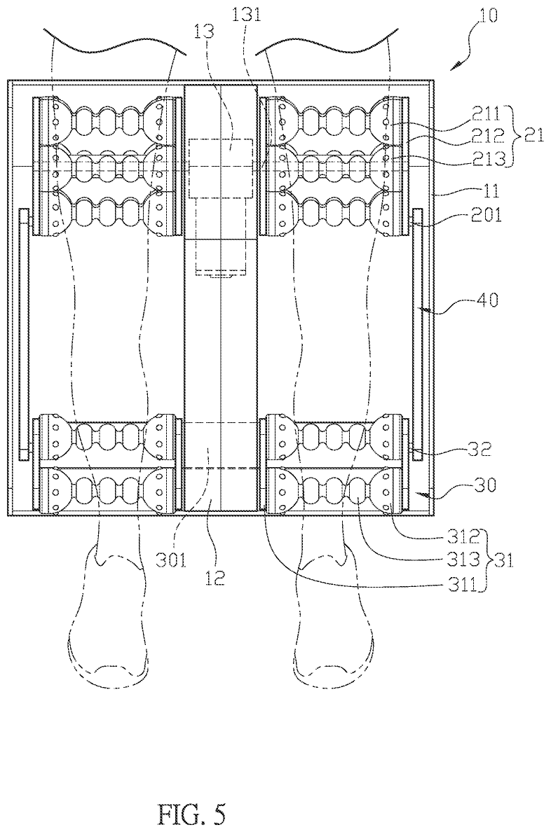

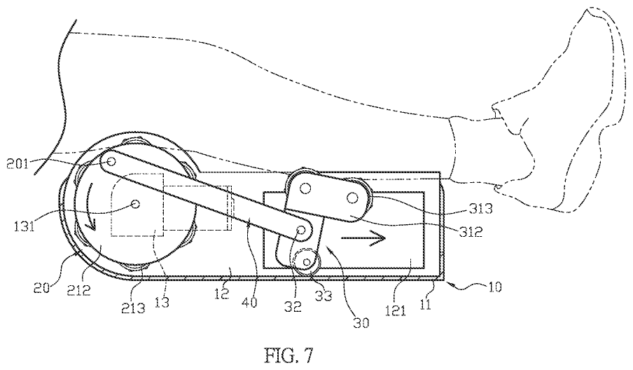

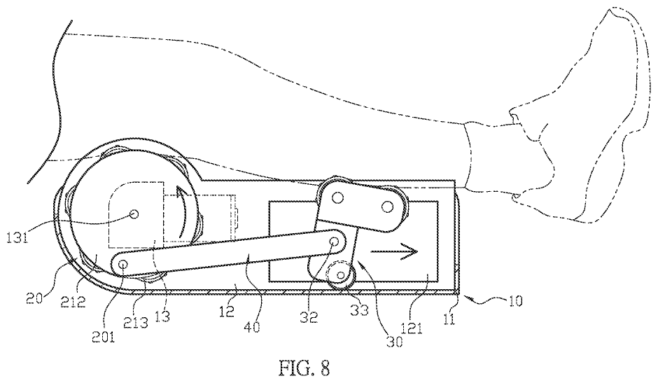

As shown in FIGS. 5-8, according to the first embodiment of the present invention, in the actual use, the user places both feet on the rolling massage part 20 and the wheeling massage part 30, the power shaft 131 uses the power motor 13 to provide power transmission, so that the rolling massage part 20 starts to rotate and rolls and massages the inner thigh of the user with the rolling massage unit 213. Because the rolling massage part 20, the transmission rod 40, the wheeling massage part 30, and the base 10 cooperate with each other to form a crank slider mechanism, the wheeling massage part 30 starts to perform linear reciprocating motion and the wheeling massage unit 313 repeatedly pushes the inner side of the user's calf over a large area, thereby massaging the user's thigh and calf in different ways at the same time.

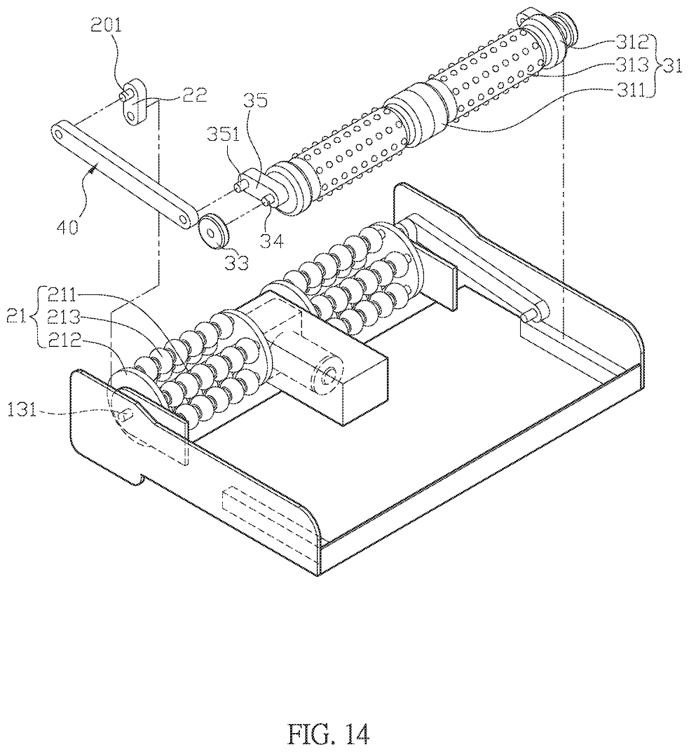

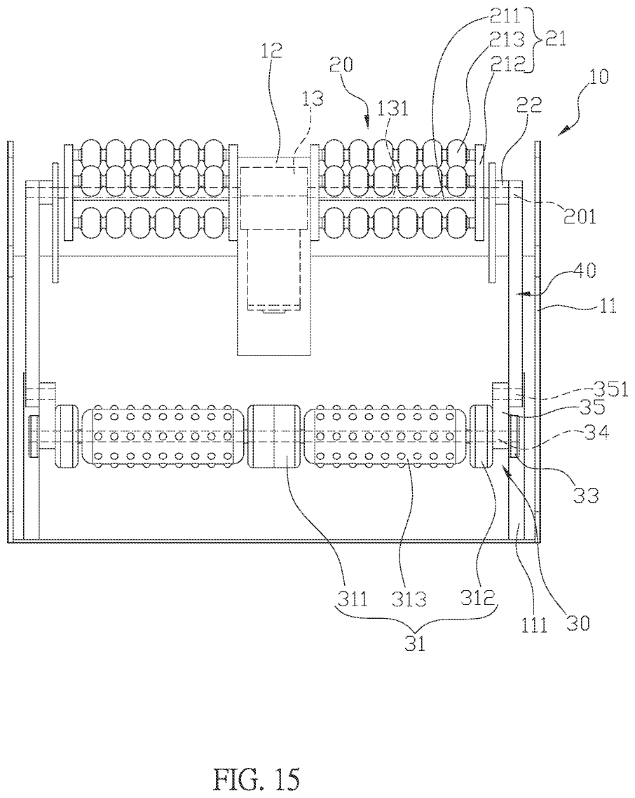

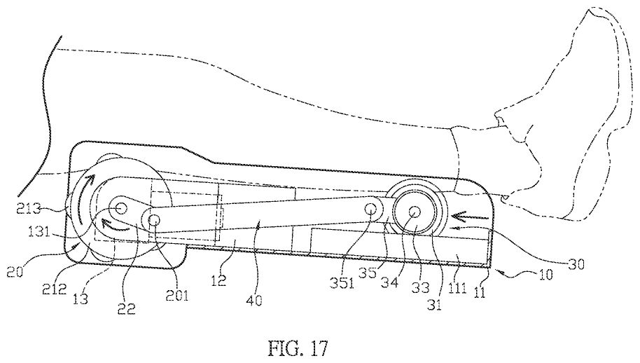

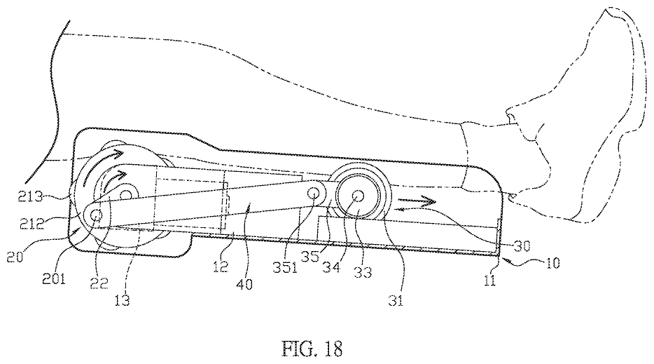

FIGS. 14-18 illustrate the second embodiment of the present invention. Compared with the first embodiment of the present invention, the difference is that the wheeling massage part 30 has two symmetrically arranged wheeling massage pieces 31, the two sides of the wheeling massage piece 31 have an inner part 311 and an outer part 312 respectively, a wheeling massage unit 313 is equipped between the inner part 311 and the outer part 312, two wheeling massage pieces 31 are set on the wheeling massage piece shaft 34, a driven arm 35 is provided on the left and right sides of the wheeling massage piece shaft 34, and the driven arm 35 is provided with a driven arm shaft 351. Two ends of the transmission rod 40 are respectively located on the eccentric shaft 201 and the driven arm shaft 351, when the power motor 13 outputs power to rotate, the rolling massage part 20, the transmission rod 40, and the wheeling massage part 30 form a crank slider mechanism through transmission, so that when the roller massage part 20 rotates, the wheeling massage part 30 is pushed and pulled linearly back and forth.

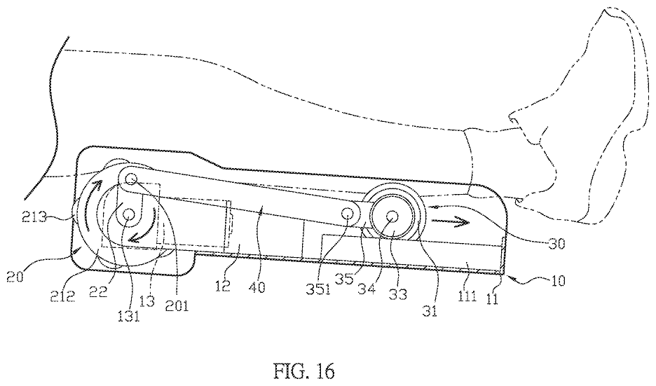

As shown in FIGS. 16-18, according to the above-mentioned second embodiment of the present invention, in actual use, the user places both feet on the rolling massage part 20 and the wheeling massage part 30, the power shaft 131 uses the power motor 13 to provide power transmission, so that the rolling massage part 20 starts to rotate and rolls and massages the inner thigh of the user with the rolling massage unit 213. Because the rolling massage part 20, the transmission rod 40, the wheeling massage part 30, and the base 10 cooperate with each other to form a crank slider mechanism, the wheeling massage part 30 starts linear reciprocating motion and uses the wheeling massage unit 313 to repeatedly press and push the inner side of the user's calf over a large area, thereby massaging the user's thigh and calf in different ways at the same time. In addition, due to the two wheeling massage pieces 31 are sleeved on the wheeling massage piece shaft 34, the wheeling massage unit 313 can rotate relative to the wheeling massage piece shaft 34, therefore, when the wheeling massage unit 313 reciprocally pushes the inner side of the user's calf, the wheeling massage unit 313 will also apply rolling force.

As shown in FIGS. 1-4 and FIGS. 6-8, taking the first embodiment as an example, the present invention provides a leg synchronization massage mechanism with rotary rolling and linear rolling. The eccentric shaft 201 is protruding outside the shaft side part 212 on one side of the rolling massage wheel 21. When the rolling massage wheel 21 rotates as its axis, the eccentric shaft 201 will deviate from the axis and rotate in a circular path.

As shown in FIGS. 14-18, taking the second embodiment as an example, the present invention provides a leg synchronous massage mechanism with rotary rolling and linear rolling, wherein the roller massage part 20 further includes a crank part 22, the crank part 22 is set at the rear ends of both sides of the power shaft 131, the eccentric shaft 201 is located on the crank part 22, when the power shaft 131 rotates, the eccentric shaft 201 will move in a circular trajectory.

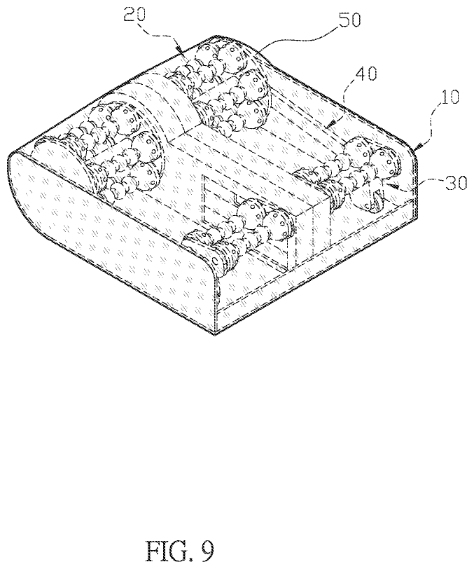

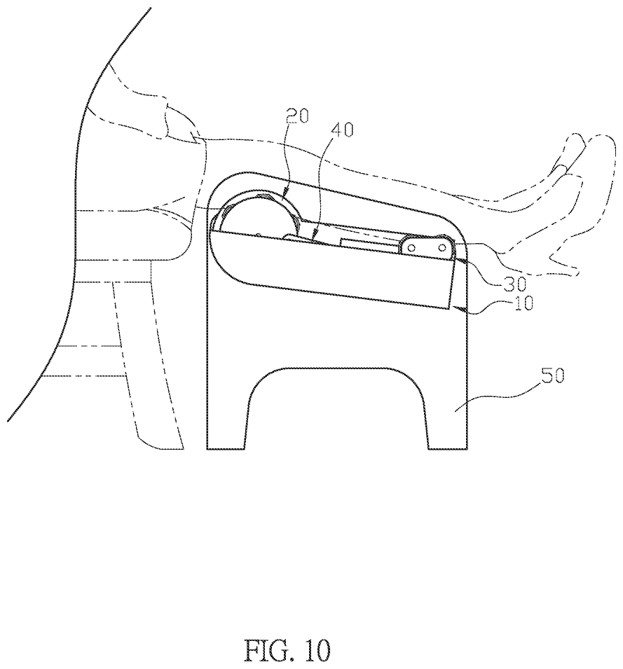

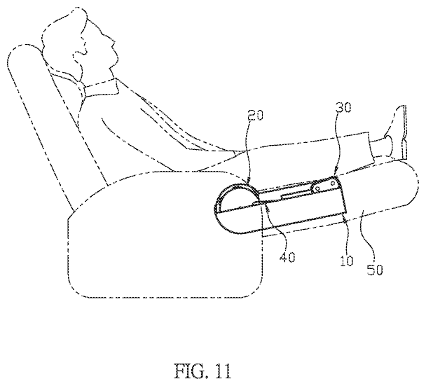

As shown in FIGS. 9-11, the present invention provides a leg synchronous massage mechanism with rotary rolling and linear rolling, wherein the base 10 is covered with a shielding part 50 used to cover the base 10, the rolling massage part 20, the wheeling massage part 30, and the transmission rod 40. The shielding part 50 is a cloth cover, a chair, a stool, a sofa, or a massage chair, and the shielding part 50 can achieve the effect of evenly dispersing the massage force.

The present invention provides a leg synchronous massage mechanism with rotary rolling and linear rolling, wherein the wheeling massage part 30 is attached to the base 10 in a sliding contact manner.

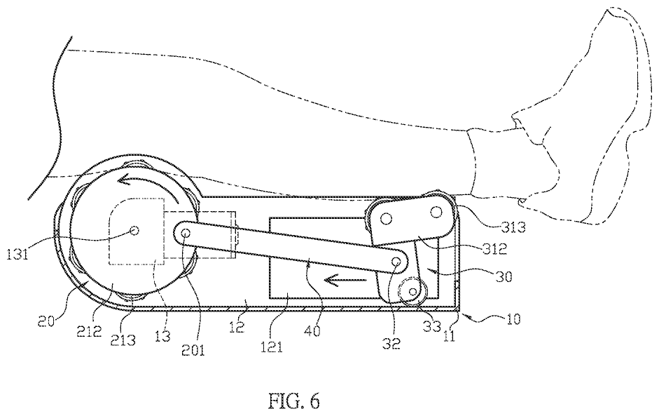

As shown in FIGS. 6-8, taking the first embodiment as an example, the present invention provides a leg synchronous massage mechanism with rotary rolling and linear rolling, wherein the wheeling massage part 30 is provided with at least one roller 33, the wheeling massage part 30 is attached to the base 10 in a rolling contact manner, so that the wheeling massage part 30 can perform reciprocating linear motion more smoothly.

As shown in FIGS. 1-4, taking the first embodiment as an example, the present invention provides a leg synchronous massage mechanism with rotary rolling and linear rolling, wherein the base central part 12 extends and is provided with a guide rail 121 running through the side, the wheeling massage part 30 is inserted into the guide rail 121, so that the connecting part 301 is limited to the guide rail 121 to prevent the position of the wheeling massage part 30 from moving up and down.

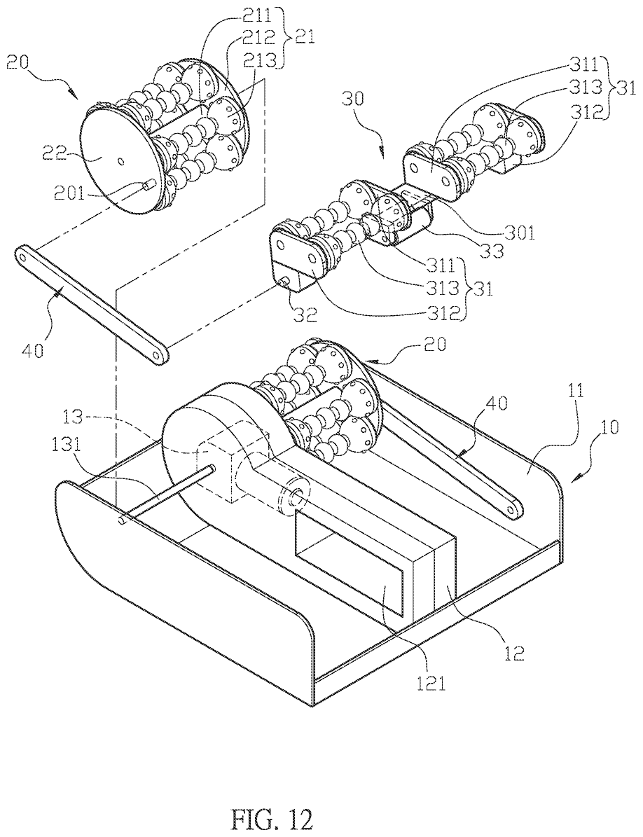

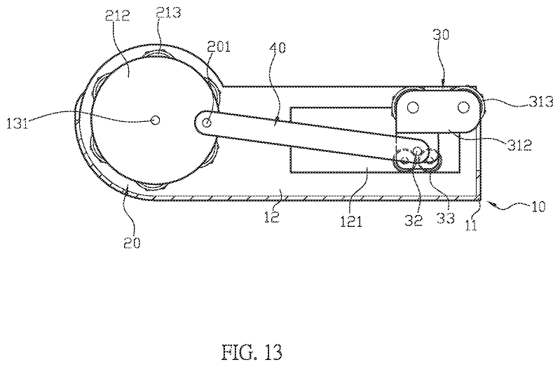

As shown in FIGS. 12-13, which is another aspect of the first embodiment, the present invention provides a leg synchronous massage mechanism with rotary rolling and linear rolling, wherein the wheeling massage part 30 is provided with at least one roller 33, the base central part 12 extends and is provided with a guide rail 121 running through the side, the wheeling massage part 30 is installed on the guide rail 121, the connecting part 301 is limited in the guide rail 121, and the roller 33 is provided at the bottom of the connecting part 301. When the wheeling massage part 30 is inserted into the guide rail 121, the roller 33 can roll and contact the guide rail 121, making the movement direction of the wheeling massage part 30 smoother.

As shown in FIGS. 14-18, taking the second embodiment as an example, the present invention provides a leg synchronous massage mechanism with rotary rolling and linear rolling, wherein a roller 33 is provided at each of the left and right ends of the wheeling massage piece shaft 34, so that the wheeling massage part 30 is attached to the base 10 in a rolling contact manner, the base body 11 is provided with a guide edge 111 on each left and right sides, and the roller 33 rolls in contact with the guide edge 111 to adjust the height of the wheeling massage part 30 during reciprocating motion.

As shown in FIGS. 1-4, the present invention provides a leg synchronous massage mechanism with rotary rolling and linear rolling, wherein the rolling massage unit 213 and the wheeling massage unit 313 are composed of several roller balls and can roll relative to its axis.

As shown in FIGS. 14-18, the present invention provides a leg synchronous massage mechanism with rotary rolling and linear rolling, wherein the wheeling massage unit 313 is a roller with flanges on the surface.

With the above-mentioned structure, the leg synchronous massage mechanism with rotary rolling and linear rolling has the following advantages. (1) The user places the legs on the rolling massage part 20 and the wheeling massage part 30. When the power shaft 131 rotates, the rolling massage part 20 rotates accordingly, and the rolling massage unit 213 contacts the thigh, so that massage can be performed by rotating and rolling. Due to the existence of the eccentric shaft 201, the wheeling massage part 30 also performs linear reciprocating motion, so that the wheeling massage unit 313 contacts the calf and can perform massage with linear wheel pressure, thereby it achieves the function of massaging the thigh and the calf in different ways at the same time and meets the need of massaging different areas of the thigh and the calf. (2) The base 10, the rolling massage part 20, the wheeling massage part 30, and the transmission rods 40 are all symmetrically arranged, so that the mechanism operates symmetrically, and the center of gravity is stable. Only one power motor 13 is used to synchronously control the movement of the rolling massage part 20 and the wheeling massage part 30, reducing cost, volume, and weight, and maintaining the consistency of thigh and calf massage frequency.

What is claimed is:

1. A leg synchronous massage mechanism with rotary rolling and linear rolling, comprising a base, two rolling massage parts, a wheeling massage part, and two transmission rods, wherein:
the base comprises a base body, the base body is provided with a base central part in the center, a power motor is provided in the base central part, and the power motor extends a power shaft on both sides;
the rolling massage part comprises a rolling massage wheel, the rolling massage wheel has a sleeve shaft in the center, there are two shaft side parts on both sides of the sleeve shaft, the sleeve shaft is sleeved on the power shaft for coaxial arrangement, the rolling massage wheel has the power shaft as its axis to annularly provide at least one rolling massage unit between two shaft side parts, the rolling massage part is protrudingly provided with an eccentric shaft, when the rolling massage part is driven using the power shaft as the axis, the eccentric shaft will deviate from the axis and rotate in a circular path;
the wheeling massage part comprises two symmetrically arranged wheeling massage pieces, the wheeling massage piece has an inner part and an outer part on both sides, there is at least one wheeling massage unit between the inner part and the outer part, the outer part is protruding with a driven shaft, and the two wheeling massage pieces are connected into one body with a connecting part; and
both ends of the transmission rod are respectively provided on the eccentric shaft and the driven shaft, when the power motor outputs power to rotate, the rolling massage part, the transmission rod, the wheeling massage part, and the base cooperate with each other to form a crank slider mechanism so that the rolling massage part can push and pull the wheeling massage part back and forth in a straight path when rotating.

2. A leg synchronous massage mechanism with rotary rolling and linear rolling, comprising a base, two rolling massage parts, a wheeling massage part, and two transmission rods, wherein:
the base comprises a base body, the base body is provided with a base central part in the center, a power motor is provided in the base central part, and the power motor extends a power shaft on both sides;
the rolling massage part comprises a rolling massage wheel, the rolling massage wheel has a sleeve shaft in the center, there are two shaft side parts on both sides of the sleeve shaft, the sleeve shaft is sleeved on the power shaft for coaxial arrangement, the rolling massage wheel has the power shaft as its axis to annularly provide at least one rolling massage unit between two shaft side parts, the rolling massage part is protrudingly provided with an eccentric shaft, when the rolling massage part is driven using the power shaft as the axis, the eccentric shaft will deviate from the axis and rotate in a circular path;
the wheeling massage part comprises two symmetrically arranged wheeling massage pieces, the two sides of the wheeling massage piece have an inner part and an outer part respectively, a wheeling massage unit is equipped between the inner part and the outer part, two wheeling massage pieces are set on the wheeling massage piece shaft, a driven arm is provided on the left and right sides of the wheeling massage piece shaft, and the driven arm is provided with a driven arm shaft; and
two ends of the transmission rod are respectively located on the eccentric shaft and the driven arm shaft, when the power motor outputs power to rotate, the rolling massage part, the transmission rod, and the wheeling massage part form a crank slider mechanism through transmission, so that when the roller massage part rotates, the wheeling massage part is pushed and pulled linearly back and forth.

3. The leg synchronous massage mechanism with rotary rolling and linear rolling of claim 1, wherein the eccentric shaft is protruding outside the shaft side part on one side of the rolling massage wheel, when the rolling massage wheel rotates as its axis, the eccentric shaft deviates from the axis and rotate in a circular path.

4. The leg synchronous massage mechanism with rotary rolling and linear rolling of claim 2, wherein the eccentric shaft is protruding outside the shaft side part on one side of the rolling massage wheel, when the rolling massage wheel rotates as its axis, the eccentric shaft deviates from the axis and rotate in a circular path.

5. The leg synchronous massage mechanism with rotary rolling and linear rolling of claim 1, wherein the roller massage part further comprises a crank part, the crank part is set at the rear ends of both sides of the power shaft, the eccentric shaft is located on the crank part, when the power shaft rotates, the eccentric shaft moves in a circular trajectory.

6. The leg synchronous massage mechanism with rotary rolling and linear rolling of claim 2, wherein the roller massage part further comprises a crank part, the crank part is set at the rear ends of both sides of the power shaft, the eccentric shaft is located on the crank part, when the power shaft rotates, the eccentric shaft moves in a circular trajectory.

7. The leg synchronous massage mechanism with rotary rolling and linear rolling of claim 1, wherein the base is covered with a shielding part used to cover the base, the rolling massage part, the wheeling massage part, and the transmission rod, and the shielding part comprises a cloth cover, a chair, a stool, a sofa, or a massage chair.

8. The leg synchronous massage mechanism with rotary rolling and linear rolling of claim 2, wherein the base is covered with a shielding part used to cover the base, the rolling massage part, the wheeling massage part, and the transmission rod, and the shielding part comprises a cloth cover, a chair, a stool, a sofa, or a massage chair.

9. The leg synchronous massage mechanism with rotary rolling and linear rolling of claim 1, wherein the wheeling massage part is provided with at least one roller, the wheeling massage part is attached to the base in a rolling contact manner, so that the wheeling massage part can perform reciprocating linear motion more smoothly.

10. The leg synchronous massage mechanism with rotary rolling and linear rolling of claim 1, wherein the base central part extends and is provided with a guide rail running through the side, the wheeling massage part is inserted into the guide rail, so that the connecting part is limited in the guide rail.

11. The leg synchronous massage mechanism with rotary rolling and linear rolling of claim 1, wherein the wheeling massage part is provided with at least one roller, the base central part extends and is provided with a guide rail running through the side, the wheeling massage part is installed on the guide rail, the connecting part is limited in the guide rail, and the roller is provided at the bottom of the connecting part, and when the wheeling massage part is inserted into the guide rail, the roller rolls and contacts the guide rail.

12. The leg synchronous massage mechanism with rotary rolling and linear rolling of claim 2, wherein a roller is provided at each of the left and right ends of the wheeling massage piece shaft, so that the wheeling massage part is attached to the base in a rolling contact manner.

13. The leg synchronous massage mechanism with rotary rolling and linear rolling of claim 12, wherein the base body is provided with a guide edge on each left and right sides, and the roller rolls in contact with the guide edge to adjust the height of the wheeling massage part during reciprocating motion.
